(19) United States
(12) Patent Application Publication
(10) Pub. No.: US 2015/0066652 A1
(43) Pub. Date: Mar. 5, 2015

(54) SYSTEM AND METHOD FOR DYNAMIC CROSS-PLATFORM ALLOCATION OF THIRD-PARTY CONTENT

(71) Applicant: GOOGLE, INC., Mountain View, CA (US)

(72) Inventors: Alexander Collins, San Francisco, CA (US); Brandon Bilinski, San Francisco, CA (US)

(73) Assignee: GOOGLE, INC., Mountain View, CA (US)

(21) Appl. No.: 13/773,828

(22) Filed: Feb. 22, 2013

(51) Int. Cl. G06Q 30/02

(52) U.S. Cl. CPC G06Q 30/0269
USPC 705/14.66

(57) ABSTRACT

A system and method for allocating third-party content impressions among online media formats is provided. An allocation system normalizes the number of impressions of each format so that the durations of each format may be determined so that the expected revenue of the impressions on each format is approximately equal. The allocation system assigns an optimal number of third-party content impressions to a user based on the amount of content the user consumes. The allocation system determines the probabilities of third-party contents of differing durations and formats being served to the user as a function of the user's preferred format and of an optimal amount of third-party contents to be viewed by the user. The allocation system determines whether a given third-party content should be served as a function of the probability.

### BACKGROUND

Much of the content available online is supported by revenue generated by third-party contents or articles (such as advertisements). This monetized content comes in a variety of forms, such as audio, video, text, images and web searches. Publishers of online content enable third-party content providers (such as advertisers) to place and/or access to third-party contents on the publisher's web property, such as a website or web page. Third-party content providers provide compensation for this placement. The amount of compensation may be based on a variety of factors. For example, the third-party content providers may compensate the publisher based on the number of times users of the content click on the third-party content on the publishers web page (“click through rate” or “CTR”). In another example, the third-party content providers compensate the publisher based on the cost per thousand impressions (“CPM”) served by the publisher. In yet another example, the third-party content providers compensate the publishers for actions specified by the third-party content provider, such as a purchase made of the third-party content provider's product and/or service or a form being filled out.

Facilitation of these activities may be accomplished by a third-party content providing network. In such network, an entity, (such as a group, company or individual) connects third-party content providers with publishers. The network generally aggregates content space available from publishers and matches it with third-party content provider's demand. The network may determine which third-party contents are to be served to which content space offered by which publisher. The third-party contents are served to the publisher when the publisher displays content and are of the same format as that of the content space.

### SUMMARY

An example of a method for allocating a third-party content impression between a first format and a second format is presented (a “third-party content allocation method”). The third-party content allocation method may include creating a normalizer configured to convert a number of content impressions on the first format to a number of content impressions on the second format; receiving a user content selection; determining an optimal amount of third-party contents (hereafter referred to as an optimal third-party content amount) to be viewed by the user; and creating a probability of serving the content impression on the first format as a function of the user optimal third-party content amount and the user content selection.

The third-party content allocation method may include receiving a request for serving the third-party content impression on the first format from a publisher in response to a user request for access to a content provided by the publisher. The content allocation method may include determining whether to serve the third-party content impression on the first format as a function of the probability of serving the third-party content impression on the first format. In one example, the step of determining whether to serve the third-party content impression on the first format includes comparing the probability of serving the content impression of the first format with a random number.

In the third-party content allocation method, the normalizer may be configured to convert the number of impressions of the first format to the number of impressions of the second format as a function of an expected revenue. In another example, the normalizer is configured to convert the number of impressions of the first format to the number of impressions of the second format as a function of a canonical third-party content presentation or display format.

In one example, the number of impressions of the first format and the number of impressions of the second format are determined over a time period.

In one example, the user preference includes the first format and/or the second format.

In one example, the optimal third-party content amount for the user is a function of a number of impressions served to the user. In another example, the optimal third-party content amount for the user is a function of a sliding average of the optimal third-party content amount.

A system for allocating a third-party content impression between a first format and a second format is presented (“a third-party content allocation system”). The system may include, a normalizer module configured to convert a number of content impressions on the first format to a number of content impressions on the second format; an interface configured to receive a user selection; an optimal third-party content amount module configured to create an optimal third-party content amount for the user; and a probability module configured to create a probability of serving the third-party content impression on the first format as a function of the user optimal third-party content amount and the user selection.

The third-party content allocation system may include a selection module configured to determine whether to serve the third-party content impression on the first format as a function of the probability of serving the third-party content impression on the first format. In one example, the selection module is configured to determine whether to serve the third-party content impression on the first format by comparing the probability of serving the third-party content impression of the first format with a random number.

In one example, the interface is configured to receive a request for serving the third-party content impression on the first format from a publisher in response to a user request for access to a content provided by the publisher. In another example, the interface is configured to receive user preference that includes the first format and/or the second format.

In one example, the normalizer module is configured to convert the number of impressions of the first format to the number of impressions of the second format as a function of an expected revenue. In another example, the normalizer module is configured to convert the number of impressions of the first format to the number of impressions of the second format as a function of a canonical third-party content format. In another example, the normalizer module is configured to convert the number of impressions of the first format and the number of impressions of the second format over a time period.

In another example, the optimal third-party content amount module is configured to determine the optimal third-party content amount for the user as a function of a number of impressions served to the user. In another example, the optimal third-party content amount module is configured to determine the optimal third-party content amount for the user as a function of a sliding average of the optimal third-party content amount.

### BRIEF DESCRIPTION OF THE DRAWINGS

In the accompanying figures, like reference numerals refer to identical or functionally similar elements throughout the separate views.

FIG. 1 is a block diagram of an exemplary third-party content allocation environment.

FIG. 2 is a block diagram of an exemplary third-party content provider system.

FIG. 3 is a block diagram of an exemplary publisher system.

FIG. 4 is a block diagram of an exemplary user computer.

FIG. 5 is a block diagram of an exemplary third-party content allocation system.

FIG. 6 is a flow chart of an exemplary method for allocating third-party content impressions among a plurality of formats.

Elements in the figures are illustrated for simplicity and clarity and have not necessarily been drawn to scale. For example, the dimensions of some of the elements in the figures may be exaggerated relative to other elements. Further, the apparatus and method components have been represented, where appropriate, by conventional symbols in the drawings.

### DETAILED DESCRIPTION

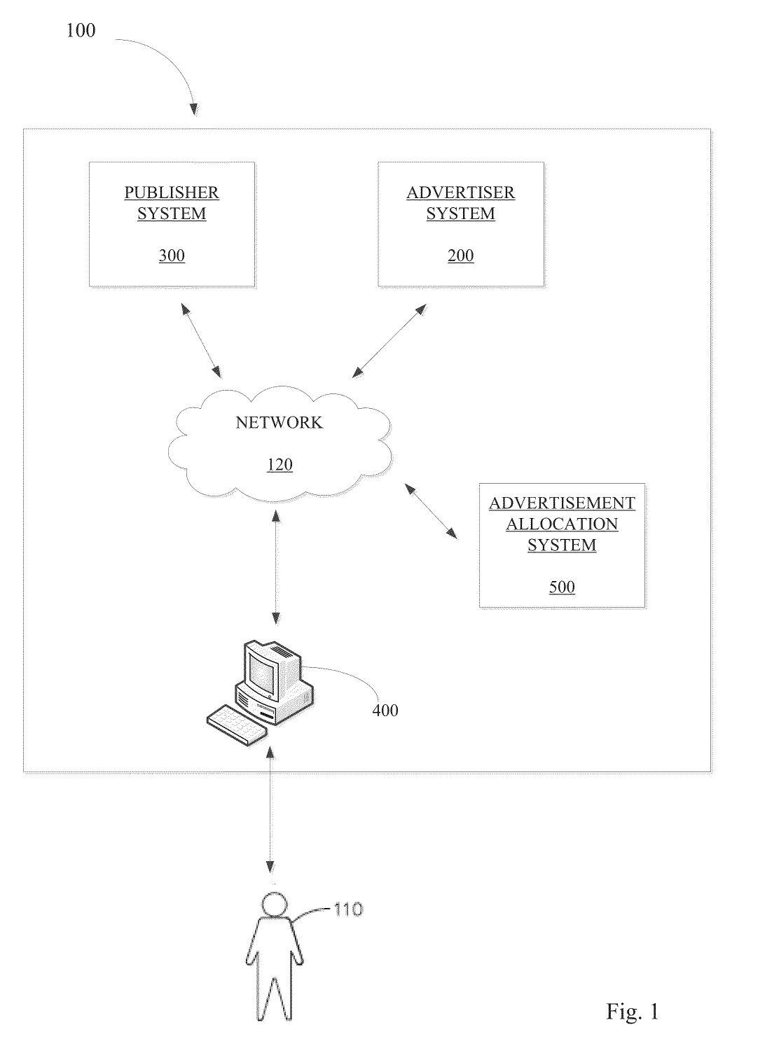

FIG. 1 depicts an example of an environment for allocating third-party contents among differing online media formats (“third-party content allocation environment”) 100. The third-party content allocation environment 100 generally includes a network 120, a third-party content provider system 200, a publisher system 300, a user computer 400 and a third-party content allocation system 500. In the third-party content allocation environment 100, online monetized content may be supported by third-party contents presented across media formats and platforms. An entity (“user”) 110 that accesses the content generally accesses the third-party content allocation environment 100 via the user computer 400. The user 110 is assigned an amount of third-party contents to be presented with an “optimal number or amount of third-party contents” (such as an advertisement quota) to support the amount of content the user 110 consumes. In one embodiment, an optimal third-party content amount can be measured in terms of “Expected Number of Impressions per time-period”, or “Expected Revenue for the third-party content platform generated by showing the user third-party contents per time-period”. By looking at the expected revenue per impression, and the expected number of impressions served per time-period, a mathematical product of these quantities can represent the expected revenue generated from that user for the time-period.

The user 110 may satisfy the optimal third-party content amount by consuming a number of third-party contents (each time a third-party content is served is referred to an “impression”) on any number of third-party content formats (such as audio, video, text, images and web searching) presented on any number of platforms.

As known to one of ordinary skill in the art, third-party content platforms represent third-party content systems that manage third-party content serving, analytics, etc. . . . , and third-party content formats refer to specific templated creatives (i.e., “72px square image, with 50-character max promo text” vs. “4-line text third-party content (40-character max per line), with a visible URL shown underneath the third-party content”). The optimal third-party content amount is generally determined as a function of the revenue expected to be generated by the user's exposure to third-party content impressions over a given time period.

A third-party content impression presented on one format may not be equivalent to a third-party content impression presented on another format based on a given criteria. For example, a third-party content impression of 20 seconds on an audio format may be expected to generate an amount of revenue that is higher than a third-party content impression of 20 seconds on a video format. In addition, the user may prefer to consume third-party contents on an audio format as opposed to a video format (“user preference or selection”). The third-party content provider system 200 takes into account the relative values of the third-party content impressions on differing formats and the user preference when determining which third-party content to serve to a publisher.

The third-party content provider system 200, publisher system 300, user computer 400 and the third-party content allocation system 500 are generally in communication with each other via the network 120. The network 120 enables the third-party content provider system 200, publisher system 300, user computer 400, and third-party content allocation system 500 to operate in a networked environment having logical connections among them. In one example, the network 120 includes the Internet. The third-party content provider system 200, publisher system 300, user computer 400 and the third-party content allocation system 500 may be in communication with the network 120 directly or indirectly via one or more communication systems. In another example, the third-party content provider system 200, publisher system 300, user computer 400 and third-party content allocation system 500, or any combination thereof, may not be connected by the network 120 or any other means, but instead, data may be migrated via any computer readable medium.

The third-party content provider system 200, publisher system 300, user computer 400 and/or third-party content allocation system 500 may be in communication with the network 120 directly or indirectly via one or more communication systems. These communication systems include, alone or in combination, wired and/or wireless communication technologies. Examples of wired communication technologies include, but are not limited to twisted pair wire, coaxial cable and optical cable. Examples of wireless communication technologies include, but are not limited to, terrestrial microwave, communication satellites, cellular systems, PCS systems, wireless local area networks (WLAN), infrared communications and global area networks (GAN).

In order to determine which third-party content to present to a user 110 via the publisher system 300, the third-party content allocation system 500 normalizes the number of impressions of the various formats so that the revenue generated by an impression of each format is approximately equal. This is generally determined over a given period of time. By doing so, the duration of a third-party content on a first format can be converted to a duration of a third-party content on a second format. For example, a third-party content impression of 20 seconds on a video format may be approximately equivalent to a third-party content impression of 40 seconds on an audio format in terms of expected revenue. In addition, a third-party content for the user 110 may be determined based on the normalized third-party content impressions the user consumed during a given time period. Moreover, each third-party content impression may have a specified/particular format, which includes a length (for media third-party contents like video/audio). So the normalization approximates N impressions of Format X that are equivalent to M impressions of Format Y. As such, by dividing by the duration of each impression of Format X and Format Y, an estimated conversion can be obtained between 1-second of Format X and 1-second of Format Y.

When the third-party content allocation system 500 receives a communication from the user 110 via the user computer 400, the communication generally includes the user preference. The third-party content allocation system 500 determines an optimal third-party content amount for the user 110 and determines the probability that a third-party content of a given format and duration will be presented to the user 110. This probability is computed for each format/duration combination. When the user 110 attempts to access monetized content on the publisher system 300 via the user computer 400, the publisher system 300 requests a third-party content impression on a particular format from the third-party content provider allocation system 500. The third-party content allocation system 500 determines whether to present a third-party content impression on the format specified by the publisher system 300 and serves the third-party content impression based on this determination.

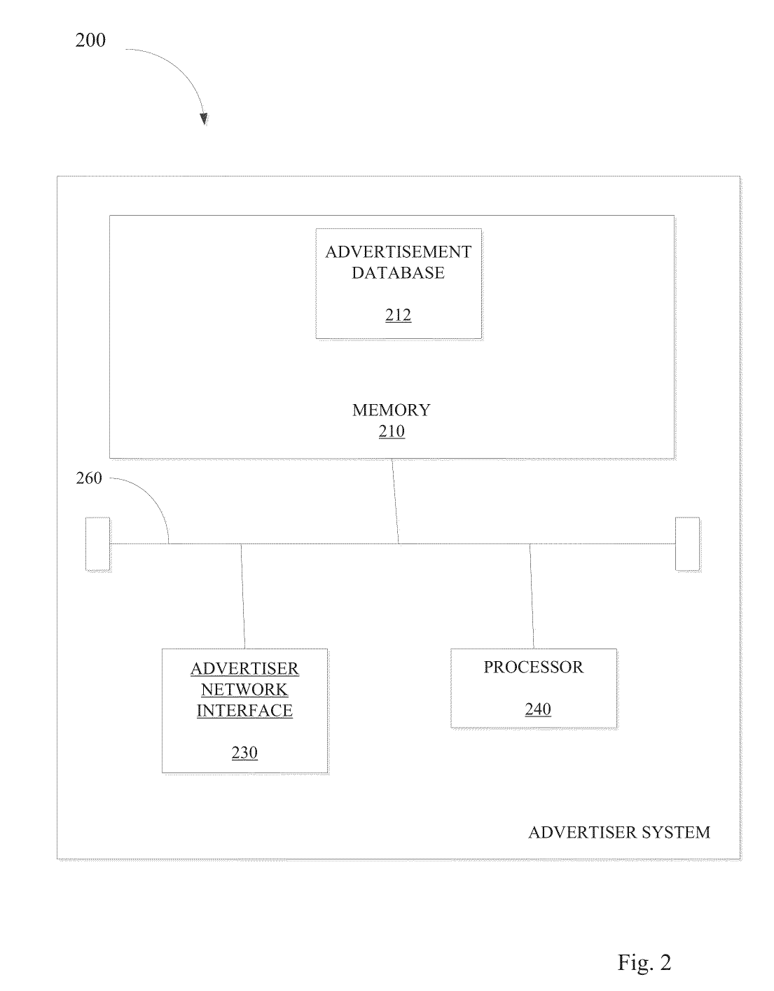

The third-party content provider system 200, publisher system 300, user computer 400 and third-party content allocation system 500 are shown in FIGS. 2, 3, 4 and 5 respectively. With reference to FIGS. 2, 3, 4 and 5, the third-party content provider system 200, publisher system 300, user computer 400 and third-party content allocation system 500 each generally include a processor 240, 340, 440 and 540, respectively. Processors 240, 340, 440 and 540 include one or more devices capable of processing digital information, such as a microprocessor. The processors 240, 340, 440 and 540 may be implemented as shown in FIGS. 2, 3, 4 and 5. However, the processors 240, 340, 440 and 540 may be implemented in one or more devices located in, near and/or remote from the third-party content provider system 200, publisher system 300, user computer 400, and/or third-party content allocation system 500.

The third-party content provider system 200, publisher system 300, user computer 400 and third-party content allocation system 500 each generally include a memory 210, 310, 410 and 510, respectively. Memories 210, 310, 410 and 510 include any device or devices capable of storing computer readable instructions and/or data. Memories 210, 310, 410 and 510 may include magnetic media like a floppy disk that may be read by a floppy disk drive, a hard disk drive and magnetic tape; optical media like a Compact Disc (CD), a Digital Video Disk (DVD), and a Blu-ray Disc which may be read by an optical disk drive; and solid state memory such as random access memory (RAM), flash memory, and read only memory (ROM). The memories 210, 310, 410 and 510 may be implemented as shown in FIGS. 2, 3, 4 and 5. However, the memories may be implemented in one or more devices located in, near and/or remote from the third-party content provider system 200, publisher system 300, user computer 400 and/or third-party content allocation system 500.

The publisher system 300 may include a request generation module 314 stored in memory 310. The third-party content allocation system 500 may include an optimal third-party content amount module 514 (hereafter referred to as optimal amount module 514), normalizer module 516 and probability module 520 stored in memory 510. The third-party content allocation system 500 may further include a selection module 512 in the memory 510. Modules 314, 512, 514, 516 and 520 may include computer executable software. Alternatively, modules 314, 512, 514, 516 and 520 may be implemented apart from memories 310 and 510, respectively. In this case, the modules 314, 512, 514, 516 and 520 may include separate devices, which may include a processor and/or memory in which the computer readable software is stored.

The third-party content provider system 200, publisher system 300, user computer 400 and the third-party content allocation system 500 each generally include one or more interfaces. The third-party content provider system 200 may include a third-party content provider network interface 230. The publisher system 300 may include a publisher network interface 330. The user computer 400 may include a system interface 430. The third-party content allocation system 500 may include an allocation network interface 530. These interfaces 230, 330, 430 and 530 include input and output devices and computer executable software that enable the third-party content provider system 200, publisher system 300, user computer 400 and third-party content allocation system 500 to communicate with network 120 and thus to each other.

The interfaces 230, 330, 430 and 530 generally include devices and/or software capable of generating, transmitting and receiving electrical and/or electromagnetic signals. For example, the interfaces 230, 330, 430 and 530 may include a wired device, such as a modem and/or a wireless device, such as a radio. The radio may communicate according to various communications protocols.

The third-party content provider system 200, publisher system 300, user computer system 400 and the third-party content allocation system 500 each generally include a bus 260, 360, 460 and 560, respectively. The buses 260, 360, 460 and 560 include a subsystem that transfers data between the components of the third-party content provider system 200, publisher system 300, user computer system 400 and the third-party content allocation system 500, respectively.

Referring to FIGS. 1 and 2, the third-party content provider system 200 generally includes a memory 210, third-party content provider network interface 230, processor 240 and bus 260. The memory 210, third-party content provider network interface 230 and processor 240 may be in communication with each other via bus 260. The memory 210 generally includes a third-party content database 212 on which one or more of the third-party providers' contents are stored. When the third-party content allocation system 500 selects one of the third-party provider's third-party contents, the content providing system 200 communicates the selected third-party content to the third-party content allocation system 500 for service to the publisher system 300.

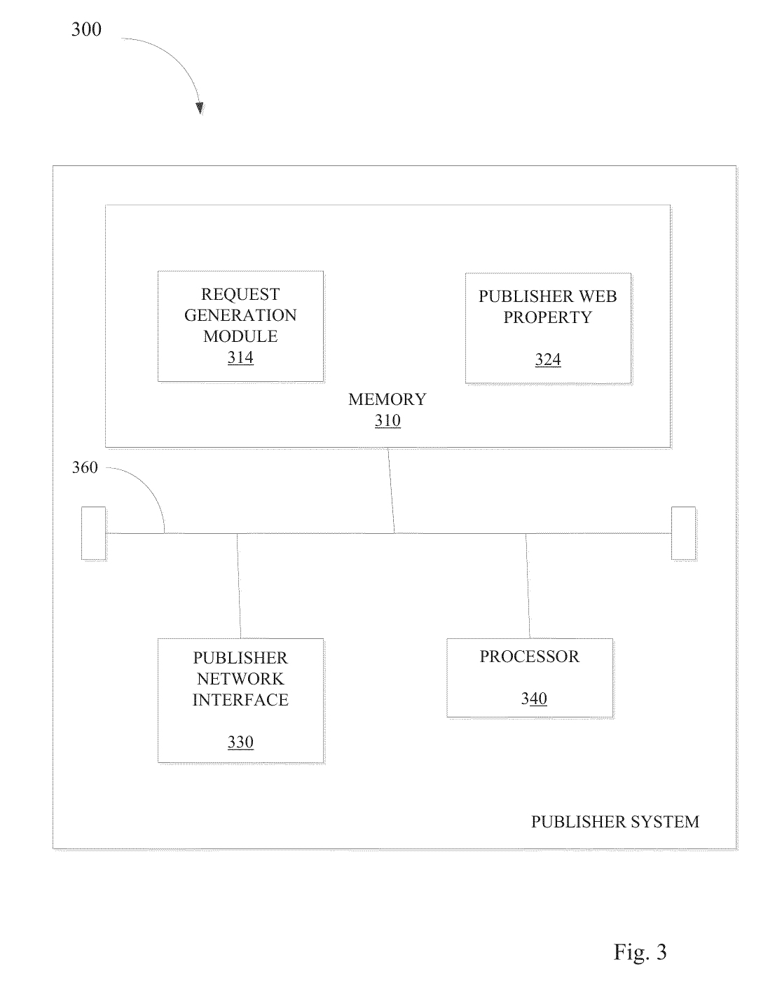

Referring to FIGS. 1 and 3, the publisher system 300 generally includes a memory 310, publisher network interface 330, processor 340 and bus 360. The memory 310, publisher network interface 330 and processor 340 may be in communication with each other via bus 360. The memory 310 generally includes a request generation module 314 and publisher web property 324. The publisher system 300 generally includes hardware and/or software that enable delivery of the publisher web property 324 to the user computer 400 via the network 120.

The publisher web property 324 may, for example, include a web site that includes one or more web pages. Other examples of web properties include mobile applications and a blogs.

The publisher network interface 330 is in communication with the third-party content allocation system 500 via network 120. The publisher network interface 330 communicates the third-party content request to the third-party content allocation system 500 and may receive a third-party content impression from the third-party content allocation system 500. The publisher network interface 330 is also in communication with the user computer 400 via network 120.

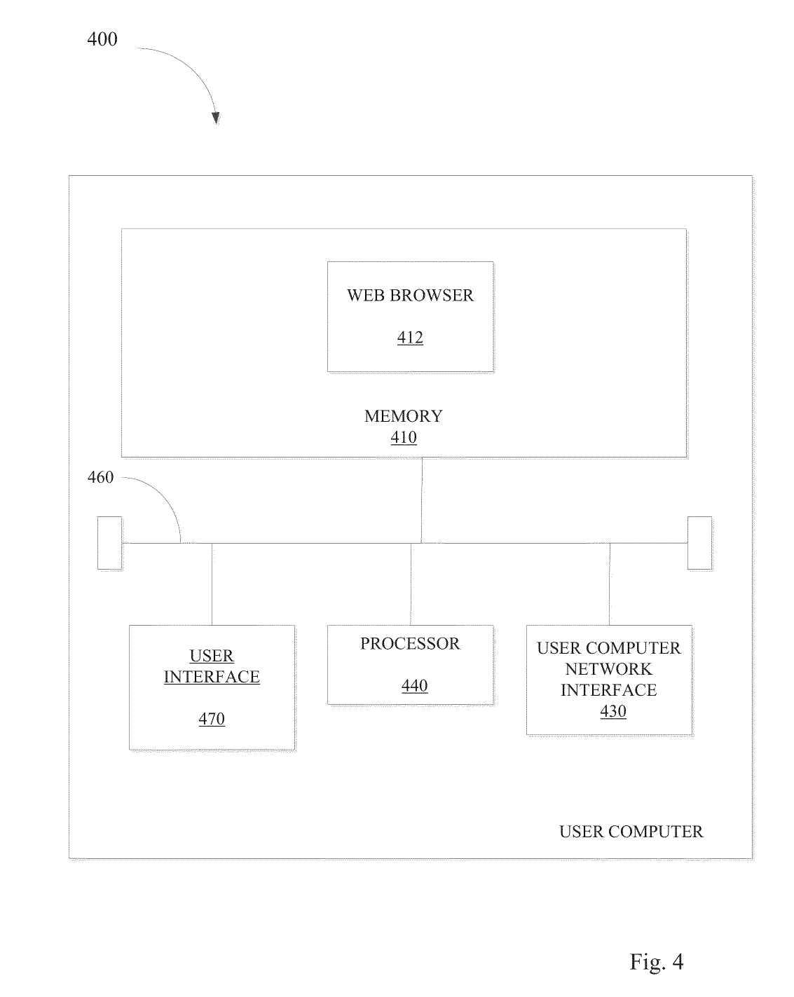

Referring to FIGS. 1 and 4, the user computer 400 generally includes a memory 410, processor 440, user computer network interface 430 and user interface 470. Memory 410, processor 440, user computer network interface 430 and user interface 470 may be in communication with each other via bus 460.

The memory 410 generally stores a web browser 412. The web browser 412 includes computer executable software used for accessing sites and information on the World Wide Web (“WWW”) and may be executed by processor 440. The web browser 412 generally retrieves, presents and traverses information resources, such as a web property. The web browser may access a web property according to the web property's uniform resource locator (“URL”). One exemplary web browser can be Google Chrome®.

The user interface 470 enables the user 110 to interact with the publisher web property 320 and the third-party content allocation system 500 via user computer 400. The user interface 470 includes input devices, output devices and/or combinations of the two. Input devices include devices through which data and/or computer executable software may entered into the user computer 400, either automatically or by the user 110 who enters commands and data. Input devices may include: an electronic digitizer or drawing board; a barcode reader, an RFID reader, a debit card reader, or any near-field communication (“NFC”) reader; a microphone; an image capture device such as a camera, a video camera, or a digital flatbed or sheet-fed scanner; a keyboard, a numeric pin pad, any device which has a series of depressible keys; a pointing device, such as a mouse, a trackball or a touch pad; any memory device, any wireless enabled device, or any networked device able to generate and transmit a signal. Other input devices may include a joystick, game pad, satellite dish, an instrument, a sensor, and the like. The user interface 470 may also include output devices including devices through which data may be communicated to a user such as, a monitor, printer and speaker. The user interface 470 may include a combination input/output device such as a touch screen.

The user computer network interface 430 may communicate requests and data to and receive data and/or executable code from the third-party content allocation system 500 via network 120. For example, the user may communicate user preferences to the third-party content allocation system 500. The user computer network interface 430 may also communicate with the publisher system 200 via the network 120. In general, the user computer network interface 430 utilizes the web browser 412 to request access to the publisher system 200 and the third-party content allocation system 500. The web browser 412 may render the resources communicated from the publisher system 200 and the third-party content allocation system 500 to the user computer 400 via a user interface 470, such as a monitor.

Referring to FIGS. 1, 4 and 5, the third-party content allocation system 500 generally includes a memory 510, allocation network interface 530, processor 540 and bus 560. The memory 510, allocation network interface 530 and processor 540 may be in communication with each other via bus 560. The memory 510 may include a user optimal amount module 514, normalizer module 516, normalizer database 518, probability module 520 and probability database 522. The memory 510 may further include a selection module 512 and a third-party content allocation web property 524.

The third-party content allocation web property 524 may, for example, include a web site that includes one or more web pages. The third-party content allocation web property 524 may be accessed by the user 110 via the web browser 412 on the user computer 400. The third-party content allocation web property 524 enables the user to communicate the user preferences to the third-party content allocation system 500. The user preferences may include the format on which the user 110 prefers to and/or not to consume third-party contents. In one embodiment, a user preference may be based on his/her past behavior, which can also be an adequate indicator of his/her future behavior. For example, if the user spends a number “H” of hours a week watching visual third-party contents for each of a number of successive weeks, then one can predict that the same user may be spending about the same number H of hours watching visual third-party contents during a week that is close to the previous successive weeks. The third-party content allocation web property 524 may include preset preferences from which the user 110 may choose.

Further, services typically include publisher-sites, apps, or any other type of third-party content supported online experience. An optimal third-party content amount represents an expected number of impressions per time-period. As such, an expected number of impressions for a given service can be a function of amount of content consumed on the service (i.e., number of pages read, number of minutes of video watched, number of levels beaten in a game, etc. . . . ).

The normalizer module 516 normalizes the number of third-party content impressions of the various formats so that the revenue generated by an impression of each format is approximately equal. This is generally determined over a given period of time. In one example, for each format, an equivalent (for example, in terms of expected revenue generation) number of third-party content impressions is determined between each of the formats. In this example, one impression on a first format may be equivalent to a plurality of impressions on a second format. This may be determined as a function of the ratio of the expected revenue per thousand impressions (RPTI) on the second format and the RPTI on the first format. In another example, the number of third-party content impressions on each format may be normalized to a canonical third-party content format. Using the normalized third-party content impression on each of the formats, the duration of a third-party content impression on each format can be converted to a duration of a third-party content impression on each of the other formats. These conversions may be stored in the normalizer database 518 indexed by user 110, format and duration of the impression.

The user optimal third-party content amount module 514 generally determines the user optimal third-party amount (hereafter referred to as optimal content amount. The user optimal content amount represents the number of third-party content impressions the user 110 may consume to access the content the user 110 consumes. The user optimal content amount may be a function of the revenue expected to be generated by serving third-party contents to the user 110 during a future time period. This expected revenue is generally a function of the number of third-party content impressions the use 110 was served during a prior time period. The user optimal content amount is determined periodically with the current user optimal content amount being a function of the sliding average over a time period of previous user optimal amounts. The user optimal content amount may be stored in memory 510.

The probability module 520 determines the likelihood that a given third-party content will be selected for service to a given user 110 for the various combinations of impression format and duration. The probability module 520 determines this probability for each combination of format and duration. The probability for the user 110 to be served an third-party content on a specific format for a specific duration is a function of the probability of the user 110 reaching the user optimal content amount given the user preference as to format and how much time is left in the period over which the optimal content amount is determined These probabilities may be stored in the probability database 522.

The third-party content allocation system 500 may also include a selection module 512. The selection module 512 receives requests for third-party contents from the publisher system 300, generally as a response to the publisher system 300 when the user 110 attempts to access content on the publisher system 300. The request received from the publisher system 300 is usually for a third-party content of a particular format and duration. For example, a publisher system 300 that provides audio content will generally requests a third-party content in an audio format. When the selection module 512 receives such a request, it communicates with the normalizer database 518 and determines the duration of a third-party content of the format indicated in the user preference that corresponds to the duration and format of the third-party content requested by the publisher system 300. The selection module 512 communicates with the probability database 522 to determine the probability of a third-party content of the format specified by the user 110 for the corresponding duration. The selection module 512 compares this probability with a random number or with a predetermined threshold probability number and determines whether to serve the third-party content format and duration specified by the publisher system 300. In one embodiment, a variable P may be a function that has as variables user preferences, past-data, and particular third-party content impressions requested. For a particular third-party content impression, this impression is served on if the function P is less than a random generated number between number zero (“0”) and number one (“1”).

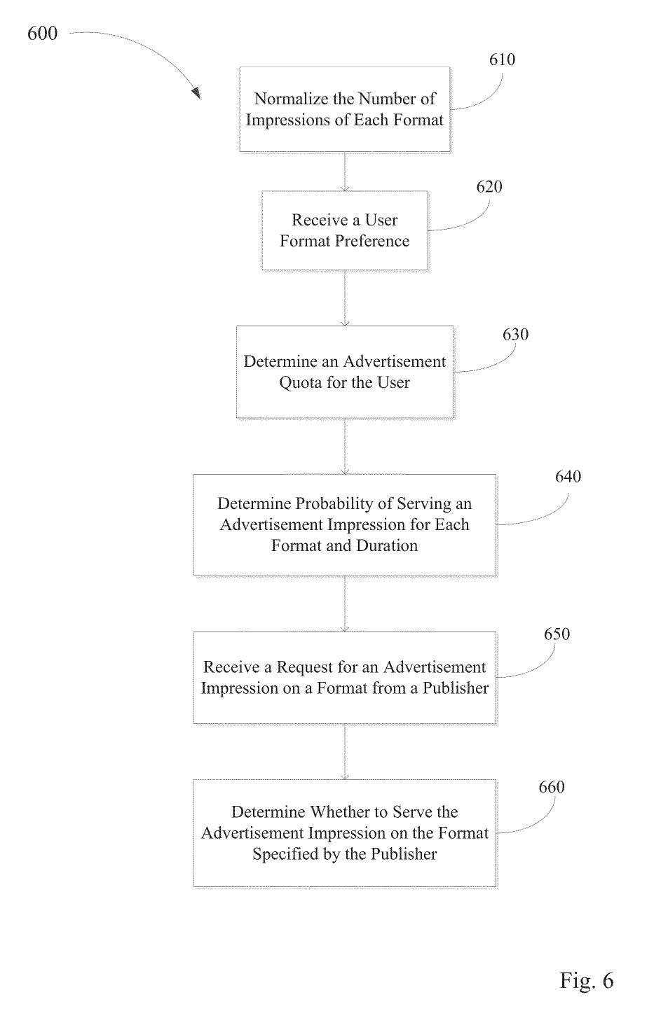

FIG. 6, with reference to FIGS. 1, 3 and 5, depicts a method for allocating third-party content impressions among a plurality of media formats (“allocation method”). In step 610, the number of impressions of each format and each duration combination are normalized by the normalizer module 516 of the third-party content allocation system 500 so that a duration for each format may be determined so that each combination of format and duration result in approximately equivalent expected revenues. In step 620, a user preference, generally as to the format on which the user prefers to consume third-party contents, is received from the user 110 via the user computer 400.

In step 630, an optimal third-party content amount is determined for the user 110. This optimal third-party content amount is based on the user's 110 past consumption of content over a given time period and the expected revenue that may be generated by the user consuming third-party contents over a future time period.

In step 640 the probability of serving a third-party content of each of the various format and duration combinations is determined In step 650, a request for a third-party content is received from the publisher system 300. This request specifies the format and duration of the requested third-party content. In step 660, it is determined whether to serve a third-party content in the format and duration specified by the publisher system 300 as a function of the probability of serving a third-party content in the format preferred by the user 110.

In one embodiment, prior to determining a user's optimal content amount, an estimate of the user's optimal content amount is selected as an average value of all other users' optimal content amount, until enough data can be gathered to determine whether the user should have a different optimal content amount.

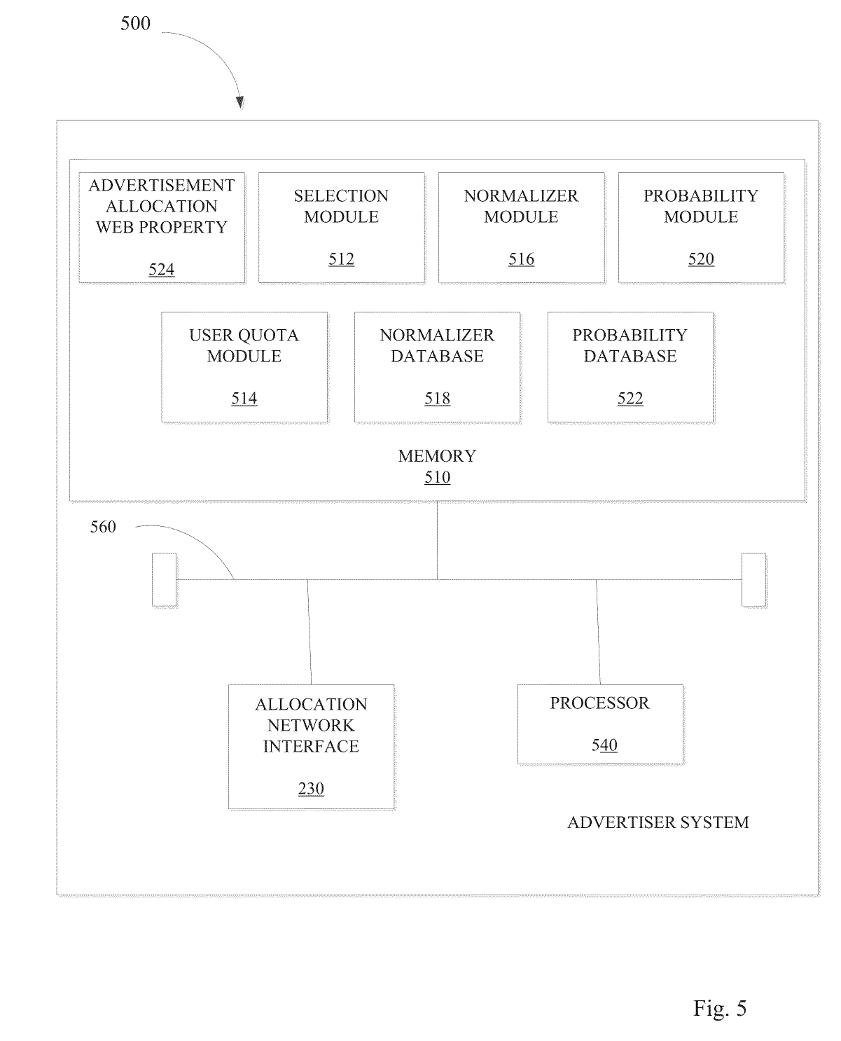

Referring back to FIG. 5, third-party content allocation system 500 is configured as an intermediary between the publishers and third-party content providers. Third-party content allocation system 500 may not impact the amount of revenue generated by each individual publisher, and may compensate based on the aggregate number of impressions the publisher expected to serve. This may involve individual cases where publishers are compensated even though the system does not show a third-party content (such as an ad), or where publishers are not compensated even though the system does show a third-party content. Overall third-party content allocation system 500 may not change the revenue seen by an individual publisher.

For situations in which the system or modules discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server or a publisher.

In the foregoing specification, specific embodiments have been described. However, various modifications and changes can be made without departing from the scope of the claims herein. For example, method steps are not necessarily performed in the order described or depicted, unless such order is specifically indicated. Accordingly, the specification and figures are to be regarded in an illustrative rather than a restrictive sense, and all such modifications are intended to be included within the scope of the claims.

It will be appreciated that some embodiments may be comprised of one or more generic or specialized processors such as microprocessors, digital signal processors, customized processors and field programmable gate arrays (“FPGAs”) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

1. A method for allocating a third-party content impression between a first format and a second format, comprising:
creating, by one or more processors, a normalizer configured to convert a number of third-party content impressions on the first format to a number of third-party content impressions on the second format;
receiving a user preference;
determining, by the one or more processors, an optimal amount of third-party contents to be viewed by the user within a time period; and
creating, by the one or more processors, a probability of serving the third-party content impression on the first format as a function of the user optimal third-party content amount and the user preference, creating the probability comprising determining the probability based on a likelihood an amount of the third party contents presented on the first format will reach the optimal amount in view of the user preference and a remaining time within the time period.

2. The method of claim 1 further comprising receiving a request for serving the third-party content impression on the first format from a publisher in response to a user request for access to a content provided by the publisher.

3. The method of claim 1 further comprising determining whether to serve the third-party content impression on the first format as a function of the probability of serving the third-party content impression on the first format.

4. The method of claim 3, wherein determining whether to serve the third-party content impression on the first format comprises comparing the probability of serving the third-party content impression of the first format with a predetermined threshold probability number.

5. The method of claim 1, wherein the normalizer is further configured to convert the number of impressions of the first format to the number of impressions of the second format as a function of an expected revenue.

6. The method of claim 1, wherein the normalizer is further configured to convert the number of impressions of the first format to the number of impressions of the second format as a function of a canonical third-party content format.

7. The method of claim 1, wherein the number of impressions of the first format and the number of impressions of the second format are determined over a time period.

8. The method of claim 1, wherein the user preference includes the first format and/or the second format.

9. The method of claim 1, wherein the optimal third-party content amount for the user is a function of a number of impressions served to the user.

10. The method of claim 1, wherein the optimal third-party content amount for the user is a function of a sliding average of the optimal third-party content amount.

11. A system for allocating a third-party content impression between a first format and a second format, comprising:
a normalizer module configured to convert a number of third-party content impressions on the first format to a number of third-party content impressions on the second format;
an interface configured to receive a user selection;
an optimal third-party content amount module configured to create an optimal amount of third-party contents to be viewed by the user within a time period; and
a probability module configured to create a probability of serving the third-party content impression on the first format as a function of the user optimal third-party content amount and the user selection, the probability module configured to determine the probability based on a likelihood an amount of the third party contents presented on the first format will reach the optimal amount in view of the user preference and a remaining time within the time period.

12. The system of claim 11, wherein the interface is further configured to receive a request for serving the third-party content impression on the first format from a publisher in response to a user request for access to a content provided by the publisher.

13. The system of claim 11, further comprising a selection module configured to determine whether to serve the third-party content impression on the first format as a function of the probability of serving the third-party content impression on the first format.

14. The system of claim 13, wherein the selection module is further configured to determine whether to serve the third-party content impression on the first format by comparing the probability of serving the third-party content impression of the first format with a predetermined threshold probability number.

15. The system of claim 11, wherein the normalizer module is further configured to convert the number of impressions of the first format to the number of impressions of the second format as a function of an expected revenue.

16. The system of claim 11, wherein the normalizer module is further configured to convert the number of impressions of the first format to the number of impressions of the second format as a function of a canonical third-party content format.

17. The system of claim 11, wherein the normalizer module is further configured to convert the number of impressions of the first format and the number of impressions of the second format over a time period.

18. The system of claim 11, wherein the interface is further configured to receive user preference that includes the first format and/or the second format.

19. The system of claim 11, wherein the optimal third-party content amount module is further configured to determine the optimal third-party content amount for the user as a function of a number of impressions served to the user.

20. The system of claim 11, wherein the optimal third-party content amount module is further configured to determine the optimal third-party content amount for the user as a function of a sliding average of the optimal third-party content amount.
